(19) United States
(12) Patent Application Publication
(10) Pub. No.: US 2026/0298287 A1
(43) Pub. Date: Oct. 1, 2026

(54) THRUST SYSTEM

(71) Applicant: Cummins Inc., Columbus, IN (US)

(72) Inventors: Jacob William Virostko, Columbus, IN (US); Jaison Wei, Hubei Province (CN); Leaf Li, Wuhan (CN); Bhavya Srikanth Kadambi, Roanoke, TX (US); Ma Mingye, Wuhan (CN)

(21) Appl. No.: 19/094,298

(22) Filed: Mar. 28, 2025

(51) Int. Cl. F16C 17/04

(52) U.S. Cl. CPC F16C 17/04

(57) ABSTRACT

A thrust system for assembly with a main bearing cap. The thrust system includes front and rear half thrust bearings and two of a bi-directional half thrust spacer wherein either of the thrust spacers can be assembled with either of the front and rear thrust bearings. The thrust spacer includes a tang positioned along a centerline of the thrust spacer. The tang is assembled with a tang slot in the main bearing cap and the thrust spacer is assembled with a thrust support groove in the main bearing cap to resist rotation of the thrust spacer. The thrust spacer has a spacer thickness that is less than a bearing thickness of either the front or rear thrust bearings such that the front and rear thrust bearings bear any force applied during operation of a crankshaft assembled with the main bearing cap.

### TECHNICAL FIELD

The present application relates generally to thrust system having a half-thrust bearing assembled with a bi-directional thrust spacer having an anti-rotation feature.

### BACKGROUND

A crankshaft of an internal combustion engine is rotatably supported, at a journal portion thereof, by a cylinder block lower portion of the internal combustion engine by a main bearing. The main bearing can be configured by combining a pair of half thrust bearings into a cylindrical shape. The pair of half thrust bearings receives axial force or thrust load of the crankshaft. Internal combustion engines often require high thrust capacity for the half thrust bearings. The half thrust bearing includes a slide or bearing face opposite a back face. Deflection of the slide or bearing face can inhibit thrust bearing performance.

A main bearing cap is configured and manufactured to receive and retain the half thrust bearings in thrust grooves. One technique of manufacturing thrust grooves in the main bearing cap includes machining or cutting the thrust grooves in a 360 degree machining operation at the same station as a crank bore is cut into the main bearing cap. This configuration allows the main bearing cap to be assembled with the cylinder block and tightened with bolts so that the as installed or assembly load state of the thrust grooves is machined in. Lack of perpendicularity control of the thrust grooves can impede performance of the pair of half thrust bearings.

Therefore, further contributions in this area of technology are needed.

### SUMMARY

Various aspects of the present application are contemplated. According to one aspect, a thrust system comprising: a semi-annularly shaped half thrust bearing including a slide surface opposite a back surface, wherein the half thrust bearing has a bearing thickness that spans between the slide surface and the back surface; and a semi-annularly shaped half thrust spacer having a front surface opposite a back surface, wherein the half thrust spacer has a spacer thickness that spans between the front surface and the back surface, wherein the spacer thickness is less than the bearing thickness.

In one embodiment, wherein the thrust spacer includes a tang positioned along a centerline of the thrust spacer to resist rotation of the thrust spacer.

In one embodiment, wherein the tang includes a pair of vertical edges wherein each of the edges has a tang length that corresponds to a depth of a tang slot of a main bearing cap when the half thrust spacer is assembled with the main bearing cap.

In one embodiment, wherein the thrust spacer is symmetric about a centerline of the thrust spacer.

In one embodiment, wherein the front surface is the same as the back surface of the thrust spacer.

In one embodiment, wherein the half thrust bearing includes a poke-yoke and the tang is larger than the poke-yoke.

In one embodiment, wherein the half thrust bearing includes a front thrust bearing and a rear thrust bearing, wherein the half thrust spacer is symmetric for assembly with either of the front thrust bearing or the rear thrust bearing.

According to another aspect, a thrust system comprising: a semi-annularly shaped half thrust bearing including a poke-yoke; and a semi-annularly shaped half thrust spacer having a tang positioned along a centerline of the thrust spacer to resist rotation of the thrust spacer, wherein the tang is larger than the poke-yoke.

In one embodiment, wherein the semi-annularly shaped half thrust bearing includes a slide surface opposite a back surface, wherein the half thrust bearing has a bearing thickness that spans between the slide surface and the back surface; and wherein the semi-annularly shaped half thrust spacer has a front surface opposite a back surface, wherein the half thrust spacer has a spacer thickness that spans between the front surface and the back surface, wherein the spacer thickness is less than the bearing thickness.

In one embodiment, wherein the half thrust spacer is symmetrical such that the front surface is the same as the back surface.

In one embodiment, wherein the half thrust bearing includes a front thrust bearing and a rear thrust bearing, wherein the half thrust spacer can be assembled with either of the front thrust bearing or the rear thrust bearing.

In one embodiment, wherein the tang includes a pair of vertical edges wherein each of the edges has a tang length that corresponds to a depth of a tang slot of a main bearing cap when the half thrust spacer is assembled with the main bearing cap.

According to another aspect, a thrust system for assembly with a main bearing cap comprising: a semi-annularly shaped half thrust bearing configured for assembly with the main bearing cap; a semi-annularly shaped half thrust spacer having a thrust spacer outer edge defined by an outer radius, the thrust spacer includes a tang positioned along a centerline of the thrust spacer; and wherein the main bearing cap includes a thrust support groove having a radius that corresponds to the outer radius of the thrust spacer to retain the thrust spacer assembled with the main bearing cap, the main bearing cap having a tang slot sized to receive the tang to resist rotation of the thrust spacer relative to the main bearing cap.

In one embodiment, wherein the tang slot includes a vertical slot portion having a width that is wider than a width of the tang to form a tang clearance.

In one embodiment, wherein the tang clearance is between 0.12 and 0.37 millimeters.

In one embodiment, wherein the semi-annularly shaped half thrust bearing includes a slide surface opposite a back surface, wherein the half thrust bearing has a bearing thickness that spans between the slide surface and the back surface; and wherein the semi-annularly shaped half thrust spacer has a front surface opposite a back surface, wherein the half thrust spacer has a spacer thickness that spans between the front surface and the back surface, wherein the spacer thickness is less than the bearing thickness.

In one embodiment, wherein the half thrust bearing includes a front thrust bearing and a rear thrust bearing, wherein the half thrust spacer can be assembled with either of the front thrust bearing or the rear thrust bearing.

In one embodiment, wherein each of the front and rear thrust bearings includes a poke-yoke, and wherein the tang is larger than the poke-yoke of either the front or the rear thrust bearings.

In one embodiment, wherein the poke-yoke of the front or the rear thrust bearings is configured to prevent assembly of the front or the rear thrust bearings in a backwards orientation.

In one embodiment, wherein the slide surface includes one or more ramp profiles, and the back surface is flat.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a front view of a thrust system assembled with a main bearing cap the present disclosure.

FIG. 2 is a front view of the thrust system of FIG. 1 assembled with the main bearing cap.

FIG. 3 is a front perspective view of the main bearing cap of FIG. 1 in a pre-machined configuration.

FIG. 4 is a front view of the main bearing cap of FIG. 3 in a pre-machined configuration.

FIG. 5 is a top view of the main bearing cap of FIG. 4 in a pre-machined configuration.

FIG. 6 is a bottom view of the main bearing cap of FIG. 4 in a pre-machined configuration

FIG. 7 is a front perspective view of the main bearing cap of FIG. 1.

FIG. 8 is a front perspective view of a bi-directional thrust spacer of the thrust system of FIG. 1.

FIG. 9 is a front perspective view of the thrust system assembled with the main bearing cap of FIGS. 1 and 2.

FIG. 10 is a partial exploded view of the bi-directional thrust spacer assembled with a tang slot of the main bearing cap.

FIG. 11 is a partial exploded view of a thrust relief of the front half thrust bearing.

FIG. 12 is a partial exploded view of a thrust relief of the rear half thrust bearing.

FIG. 13 is a cross-sectional view of the bi-directional thrust spacer assembled with the front half thrust bearing.

FIG. 14 is a partial perspective view of the rear half thrust bearing and the rear thrust spacer assembled on the main bearing cap.

FIG. 15 is a partial perspective view of the rear half thrust bearing and the rear thrust spacer assembled on the main bearing cap.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

A thrust system 100 includes a semi-annularly shaped half front thrust bearing 110 having a slide surface 118 opposite a back surface 119. The thrust system 100 also includes a semi-annularly shaped half rear thrust bearing 111 wherein the rear thrust bearing 111 includes a slide surface opposite a back surface. Each of the front and rear thrust bearings 110 and 111 includes a bearing thickness that spans between their respective slide surface 118 and the back surface 119. The thrust system 100 includes a semi-annularly shaped half thrust spacer 102 for assembly with each of the front and rear thrust bearings 118 and 119. As such, the thrust spacer 102 is bi-directional and one of the thrust spacer 102 can be assembled with either of the thrust bearings 118 and 119. The thrust spacer 102 includes an anti-rotation feature or tang 103 that assembles with a main bearing cap 52 to prevent rotation of the thrust spacer 102 in clockwise and anticlockwise directions. The thrust spacer 102 has a front surface 404 opposite a back surface 406. The thrust spacer 102 has a spacer thickness that spans between the front surface 404 and the back surface 406. The spacer thickness of the thrust spacer 102 is less than the bearing thickness of the front thrust bearing 110 and the bearing thickness of the rear thrust bearing 111. Beneficially, the thicker front and rear thrust bearings 110 and 111 will resist any load applied during operation of a crankshaft when the crankshaft is assembled with the main bearing cap 52. Additional benefits of the unique configuration and assembly of the thrust spacer 102 with the front and rear thrust bearings 110 and 111 is described below.

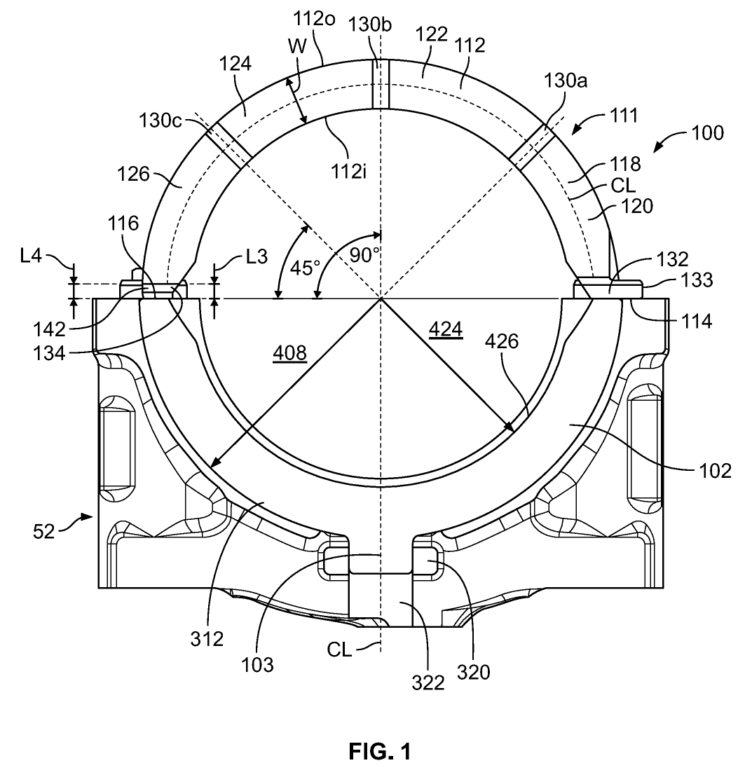

Turning now to FIGS. 1-2 and 9, is a first configuration of the front thrust bearing 110 and the rear thrust bearing 111 assembled in the main bearing cap 52. The two thrust bearings 110 and 111 are very similar except for the shape and size of a first thrust relief 132, an overhang portion 133, and a poke-yoke 135 as described and illustrated in FIGS. 12, 14, and 15. Therefore unless discussed otherwise the same details will apply to both of the front and rear thrust bearings 110 and 111.

The front thrust bearing 110 is assembled in a crankshaft assembly within an engine block. The front thrust bearing 110 includes a thrust bearing body 112 that is semicircular in shape and extends between a first end surface 114 and an opposite second end surface 116. The thrust bearing body 112 includes an inner-diameter-side end surface 112i and an outer-diameter-side end surface 112o and a width, w, that spans between the inner-diameter-side end surface 112i and the outer-diameter-side end surface 112o.

The thrust bearing body 112 includes a slide or bearing surface 118 opposite a back surface 119 wherein the slide surface 118 and the back surface 119 extend in a circumferential range between the first and second end surfaces 114 and 116, respectively. The slide surface 118 receives an axial force from a crankshaft (not illustrated) when assembled with the crankshaft during operation of the crankshaft. The slide surface 118 includes a first pad surface 120, a second pad surface 122, a third pad surface 124, and a fourth pad surface 126 that are described in further detail below. The back surface 119 is substantially flat or flat. In one embodiment, the thrust bearing body 112 is made of a bi-metal material including an aluminum clad outer surface and a steel or carbon inner surface.

The first and second pad surfaces 120 and 122, respectively, are separated by an oil groove 130a. The second and third pad surfaces 122 and 124, respectively, are separated by an oil groove 130b. The third and fourth pad surfaces 124 and 126, respectively, are separated by an oil groove 130c. The oil grooves 130a-c are similar to one another however in other embodiments the oil grooves 130a-c may be sized differently from each other. The oil grooves 130a-c are configured to retain oil therein. In one embodiment, a centerline of the oil groove 130c is about 45ᵒ from the second end surface 116, a centerline of the oil groove 130b is about 90ᵒ from the second end surface 116, and a centerline of the oil groove 130c is about 135ᵒ from the second end surface 116. In other embodiments, the oil grooves 130a-c are arranged differently on the slide surface 118. For example, the oil grooves 130a-c can be arranged such that oil grooves 130a and 130c are further apart than 45ᵒ from the centerline of the oil groove 130b.

Although the four pad surfaces 120, 122, 124, and 126 are arranged and separated by the oil grooves 130a-c in the circumferential direction on the slide surface 118 of the half thrust bearing body 112 in the present embodiment, the number of the pad surfaces 120, 122, 124, and 126 may be more than or less than four, and three to six pad surfaces are generally formed. Although three oil grooves 130a-c are arranged apart in the circumferential direction on the slide surface 118 of the half thrust bearing body 112 in the present embodiment, the number of the oil grooves 130a-c may be more than or less than three, and two to five oil grooves are generally formed.

The slide surface 118 also includes a first thrust relief 132 that spans from the first end surface 114 to the first pad surface 120. The slide surface 118 also includes a second thrust relief 134 that spans from the second end surface 116 to the fourth pad surface 126.

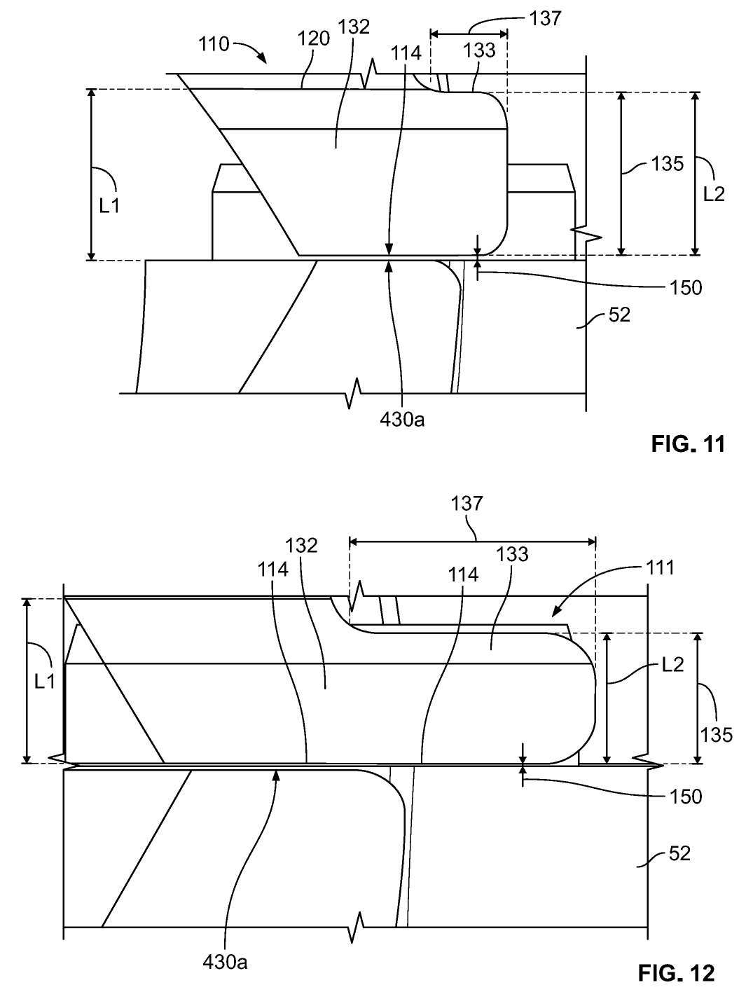

In FIG. 11, the first thrust relief 132 has a first thrust relief length L1 and a second thrust relief length L2 that are each measured in a perpendicular direction from the first end surface 114 and extend to the first pad surface 120. In the illustrated embodiment, the first thrust relief length L1 is the same or substantially the same as the second thrust relief length L2. In other embodiments, the first thrust relief length L1 is longer or shorter than the second thrust relief length L2. The first and second thrust relief lengths L1 and L2 are sized to reduce contact pressure between an engine block surface that may swell and a peak height of the slide or bearing surface 118. In one embodiment, the first and second thrust relief lengths L1 and L2 from the first end surface 114 of the half thrust bearing 110 are about 20 mm. The first end surface 114 has a clearance 150 or gap from the thrust spacer end 430a. In one embodiment, the clearance 150 is 0.13 millimeters. In another embodiment, the clearance 150 is between 0 and 0.26 millimeters.

In FIG. 12, the first thrust relief 132 has a first thrust relief length L1 and a second thrust relief length L2 that are each measured in a perpendicular direction from the first end surface 114 and extend to the first pad surface 120. The first thrust relief length L1 is longer than the second thrust relief length L2. In other embodiments, the first thrust relief length L1 is the same or substantially the same as the second thrust relief length L2. The first and second thrust relief lengths L1 and L2 are sized to reduce contact pressure between an engine block surface that may swell and a peak height of the slide or bearing surface 118. The first thrust relief 132 has an axial thickness T1 that is measured from the bottom surface 119 to a first thrust relief surface or plane 140 of the first thrust relief 132. The first thrust relief surface or plane 140 is flat or substantially flat. In the illustrated embodiment, the first thrust relief 132 includes an overhang portion 133 wherein the overhang portion 133 includes a length 135 and a width 137. In other embodiments, the first thrust relief 132 does not include the overhang portion 133. The first end surface 114 has a clearance 150 or gap from the thrust spacer end 430a. In one embodiment, the clearance 150 is 0.13 millimeters. In another embodiment, the clearance 150 is between 0 and 0.26 millimeters.

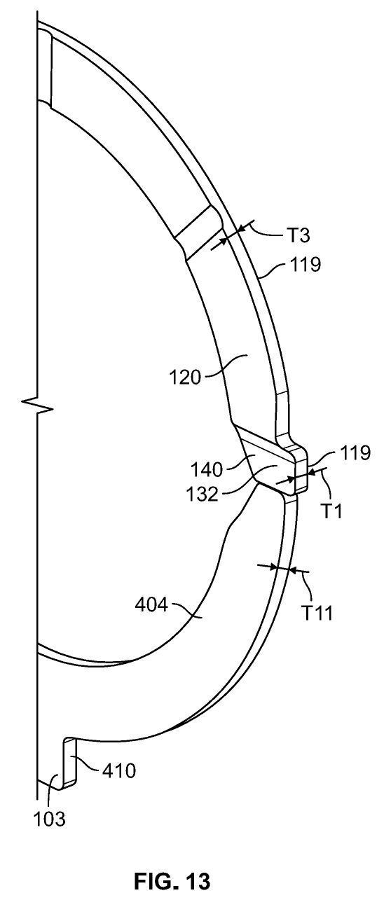

In FIG. 13, the first thrust relief 132 has an axial thickness T1 that is measured from the bottom surface 119 to a first thrust relief surface or plane 140 of the first thrust relief 132. The first thrust relief surface or plane 140 is flat or substantially flat. In the illustrated embodiment, the first thrust relief 132 includes an overhang portion 133 wherein the overhang portion 133 includes a length 135 and a width 137. In other embodiments, the first thrust relief 132 does not include the overhang portion 133.

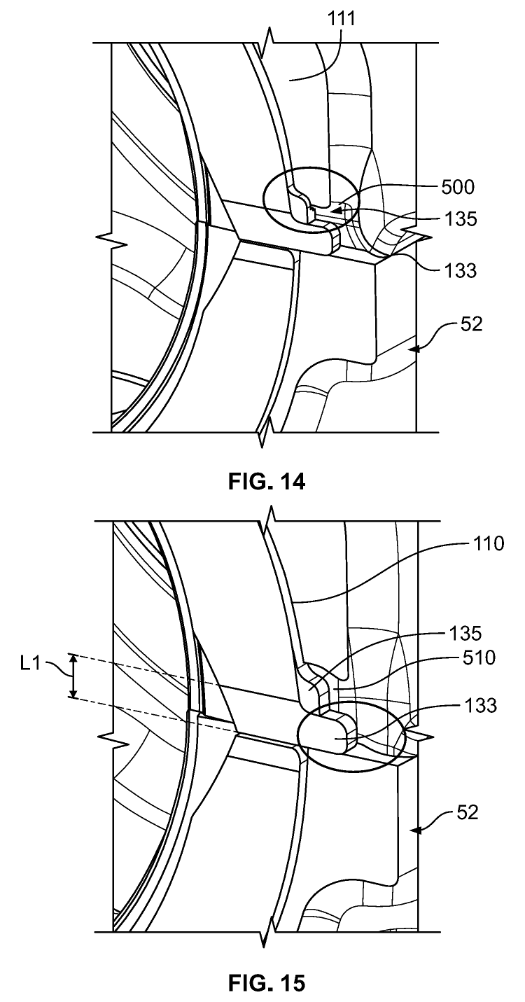

In FIG. 14, the rear half thrust bearing 111 includes the poke-yoke mechanism 135 that extends above the overhang 133. The poke-yoke 135 is included on the rear thrust bearing 111 for assembly and positional control of the rear thrust bearing 111 such that the poke-yoke 135 interferes or engages with a pocket 500 of the engine block. The poke-yoke mechanism 135 causes interference in the pocket 500 or block clearance area if the rear half thrust bearing 111 is assembled in the wrong direction, i.e., the four pad surfaces 120, 122, 124, and 126, are assembled to face towards first and a second bolt hole or counterbore 224 and 226 of the main bearing cap 52. The wrong direction would correspond to the bottom surface 119 positioned outwardly and the four pad surfaces 120, 122, 124, and 126, positioned inwardly.

In FIG. 15, the front half thrust bearing 110 includes the poke-yoke mechanism 135 that extends above the overhang 133. The poke-yoke 135 is included on the front thrust bearing 111 for assembly and positional control of the front thrust bearing 110 such that the poke-yoke 135 interferes or engages with a pocket 510 of the engine block. The poke-yoke mechanism 135 causes interference in the pocket 510 or block clearance area if the front half thrust bearing 110 is assembled in the wrong direction, i.e., the four pad surfaces 120, 122, 124, and 126, are assembled to face towards first and a second bolt hole or counterbore 224 and 226 of the main bearing cap 52. The wrong direction would correspond to the bottom surface 119 positioned outwardly and the four pad surfaces 120, 122, 124, and 126, positioned inwardly.

The poke-yoke mechanism 135 is a fail-safe feature that prevents an operator from assembling the rear half thrust bearing 111 and the front half thrust bearing 110 in the wrong directions.

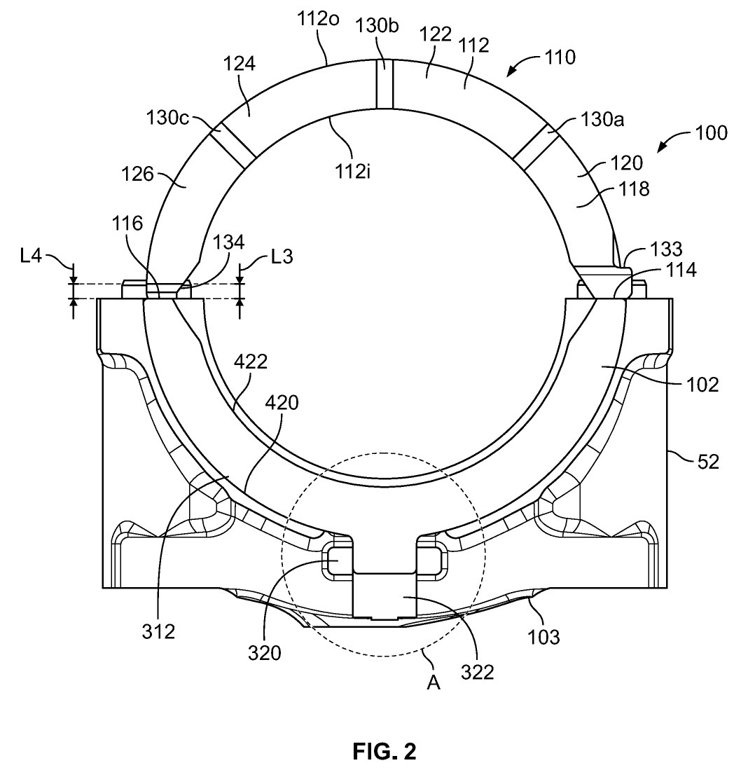

Illustrated in FIGS. 1 and 2, the second thrust relief 134 has a first thrust relief length L3 and a second thrust relief length L4 that are each measured in a perpendicular direction from the second end surface 116 and extend to the fourth pad surface 126. In the illustrated embodiment, the first thrust relief length L3 is the same or substantially the same as the second thrust relief length L4. In other embodiments, the first thrust relief length L3 is longer or shorter than the second thrust relief length L4. The first and second thrust relief lengths L3 and L4 are sized to reduce contact pressure between an engine block surface that may swell and a peak height of the slide or bearing surface 118. In one embodiment, the first and second thrust relief lengths L3 and L4 from the second end surface 116 of the half thrust bearing 110 are about 20 mm. In FIG. 9, the second thrust relief 134 has an axial thickness T2 that is measured from the bottom surface 119 to a second thrust relief surface or plane 142 of the second thrust relief 134. The second thrust relief surface or plane 142 is flat or substantially flat.

The first pad surface 120 has a first ramp profile that extends between a first peak that is a maximum height to a first valley that is a minimum or lowest height of the first pad surface 120. The first valley is located adjacent the first thrust relief 132. In one embodiment, the first ramp profile varies in an asymmetric or parabolic profile along a radial centerline CL of the slide surface 118. In one embodiment, the first peak has a profile height of about 60 to 90 microns as measured relative to the first thrust relief surface or plane 140.

The fourth pad surface 126 is similar to the first pad surface 120 and includes the first ramp profile. In one embodiment, the first ramp profile on the fourth pad surface 126 is arranged such that the first peak is closest to the second thrust relief 134. In other embodiments, other configurations of the first ramp profile are contemplated.

The second pad surface 122 has a second ramp profile wherein the second ramp profile extends between a second peak that is a maximum height to a second valley that is a minimum or lowest height of the second pad surface. In one embodiment, the second peak is located adjacent to oil groove 130b and the second valley is located adjacent the oil groove 130a. In the illustrated embodiment, the second ramp profile varies in an asymmetric or parabolic profile along a radial centerline CL of the slide surface 118. In one embodiment illustrated in FIG. 2, the second peak has a profile height of about of about 60 to 90 microns as measured relative to the first thrust relief surface or plane 140.

The third pad surface 124 is similar to the second pad surface 122 and includes the second ramp profile however the second ramp profile on the third pad surface 124 is arranged such that the second peak is closest to the oil groove 130c and the second valley is closest to the oil groove 130b. In other embodiments, other configurations of the second ramp profile are contemplated.

In FIG. 13, the half thrust bearing 110 has an axial thickness T3 that is measured from the bottom surface 119 to the slide surface 118 that includes the corresponding ramp profile of the first pad surface 120, the second pad surface 122, the fourth pad surface 126. In one embodiment, the axial thickness T3 is 4 millimeters with a variance of 0.05 millimeters. The axial thickness T3 of the half thrust bearing 110 is larger than an axial thickness T11 of the thrust spacer 102. In one embodiment, the axial thickness T11 is 3.75 millimeters with a variance of 0.10 millimeters. Beneficially since the axial thickness T11 of the thrust spacer 102 is always less than the axial thickness T3 of the front thrust bearing 110, the axial load or force from operation of the crankshaft will always be applied to the front thrust bearing 110 and similarly to the rear thrust bearing 111. The front and rear thrust bearings 110 and 111 are arranged or oriented such that the pad surfaces 120, 122, 124, and 126, and the first and second thrust reliefs 132 and 134 are facing shaft portions of a crankshaft (not illustrated) when assembled with the main bearing cap 52.

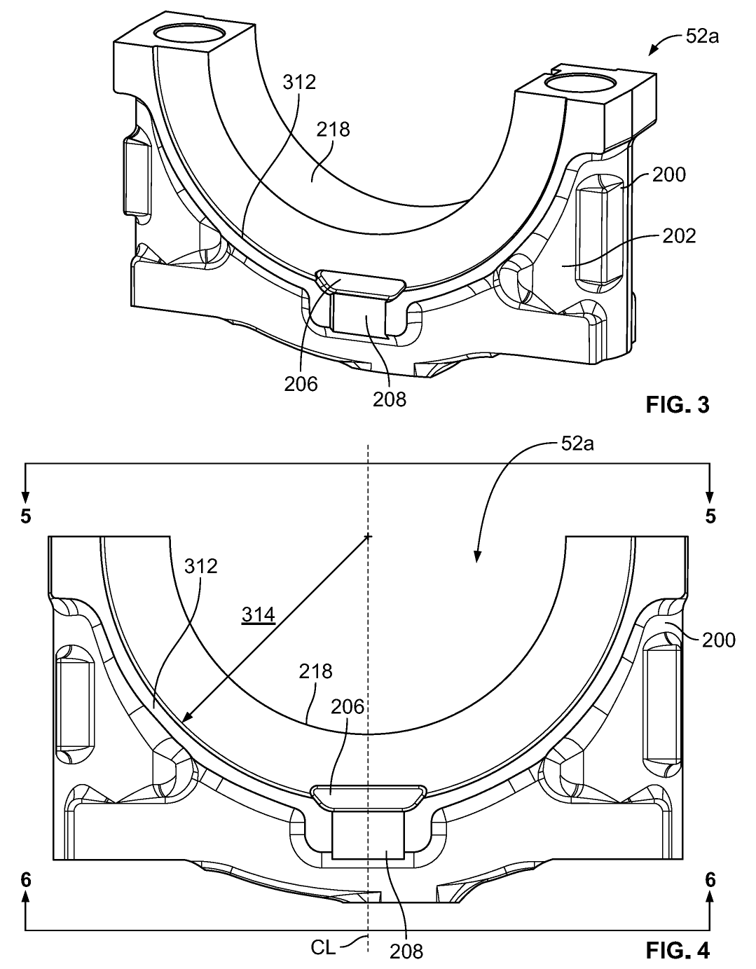

Turning now to FIGS. 3-6, is a first configuration of the main bearing cap 52 in a pre-machined configuration or pre-machined main bearing cap 52a. The pre-machined main bearing cap 52a includes a bearing housing 200 that is machined to form the main bearing cap 52. The bearing housing 200 includes a front section 202 opposite a rear section 204 (not illustrated). The front section 202 is the same as the rear section 204 unless noted otherwise therefore the front section 202 is described.

The front section 202 includes a casting relief 206 and an anti-rotation groove 208. The casting relief 206 assists with machining to avoid creating burrs or sharp corners by a milling machine or other cutting machine on the casting relief 206 for formation of a thrust support groove 312 via the casting relief 206 in the finished main bearing cap 52. The machine has a smooth transition into machining the anti-rotation groove 208 to create a tang slot 302 sized to receive the tang 103. The casting relief 206 avoids any cleanup from machining, and prevents sharp transition into thrust groove machining by the milling machine or other machinery to create the thrust support groove 312 in the finished main bearing cap 52.

The thrust support groove or bevel 312 includes a radius 314 that corresponds to an outer radius 408 of the thrust spacer 102. The radius 314 of the thrust support groove or bevel 312 can be machined, milled, or cut in different stages of operation. The thrust support groove or bevel 312 has a depth that corresponds to a thickness of the thrust spacer 102.

The tang slot 302 includes a horizontal slot portion 320 and a vertical slot portion 322 sized to receive the tang 103. The vertical slot portion 322 includes a width 324 that is slightly wider than a tang width 412 of the tang 103. The difference in the widths 324 and 412 results in a tang clearance or gap between a tang vertical edge of the tang 103 and a vertical wall 326 of the vertical slot portion 322 of the tang slot 302. In one embodiment, the tang clearance is 0.25 millimeters. In another embodiment, the tang clearance is between 0.12 and 0.37 millimeters. The tang clearance prevents rotation of the thrust spacer 102 in the thrust support groove or bevel 312 during operation of the crankshaft. Since the thrust spacer 102 is prevented from rotating due to the tight clearance, then when the front and rear bearings 110 and 111 receive a rotational force from the force of the oil film traveling over the front and rear bearings 110 and 111, the front and rear bearings 110 and 111 are also prevented from rotation. In one embodiment, the thrust spacer 102 is machined or stamped which enables a very precise formation of the tang 102 and ultimately a very small tang clearance.

The bearing housing 200 includes a crank rough bore 218 that can be machined or milled into a final crankshaft bore that is sized to receive a bottom half of a crankshaft therein.

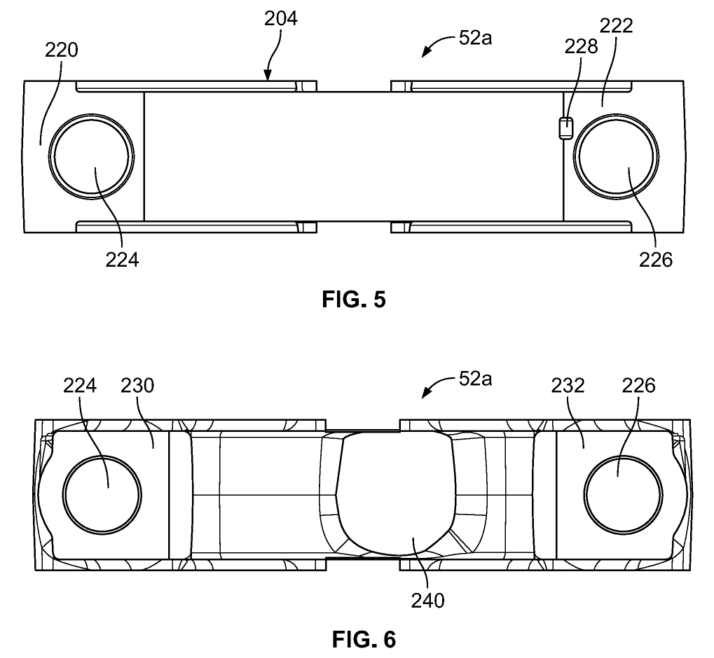

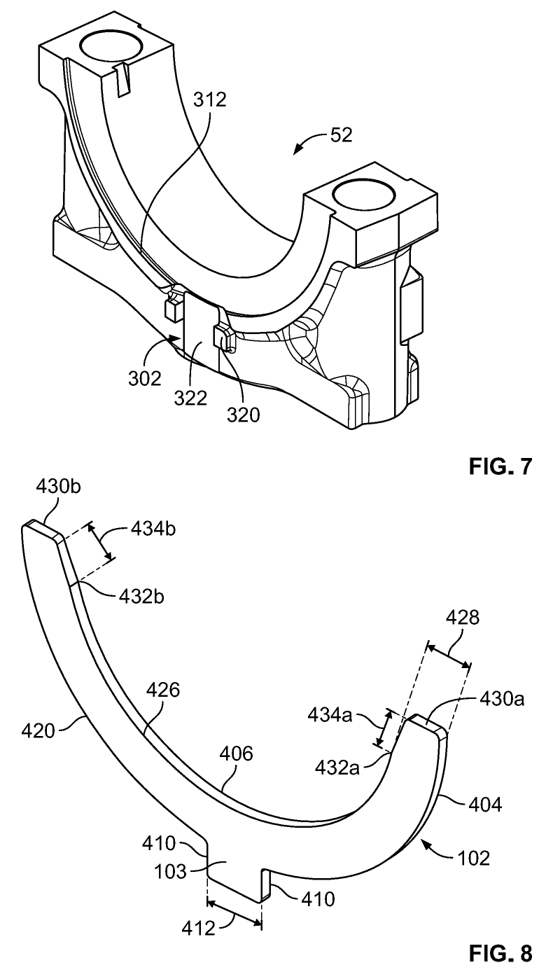

As illustrated in FIG. 5, the bearing housing 200 includes a first mating surface 220 and a second mating surface 222 that can be machined or milled. The bearing housing 200 includes a first and a second bolt hole or counterbore 224 and 226 sized to receive a bolt therein to attach the main bearing cap 52 with a structural frame (not illustrated). The bearing housing 200 includes a tang 228. As illustrated in FIG. 6, the bearing housing 200 includes a first bottom face 230 and a second bottom face 232 with a marking location 240 positioned between the first and second bottom faces 230 and 232.

The first and the second mating surfaces 220 and 222, the first and second bolt holes or counterbores 224 and 226, the anti-rotation groove 208, the crank rough bore 218, the tang slot 302, and the thrust support groove or bevel 312, can be machined or milled in a variety of different steps. For example, the pre-machined main bearing cap 52a can be assembled with an engine block and machined or milled to form each of these surfaces to avoid non-perpendicularity issues of the thrust support groove or bevel 312. This perpendicularity control comes from the spindle that is the same boring tool that machines the crank rough bore 218 and the thrust support groove or bevel 312 therefore the finished crank bore and thrust support groove or bevel 312 are perfectly aligned with each other.

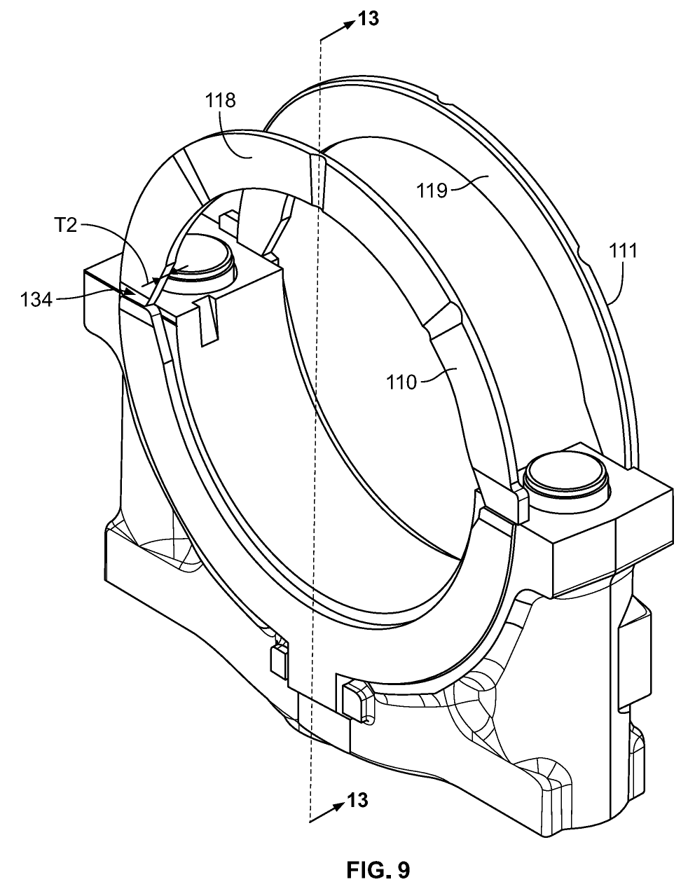

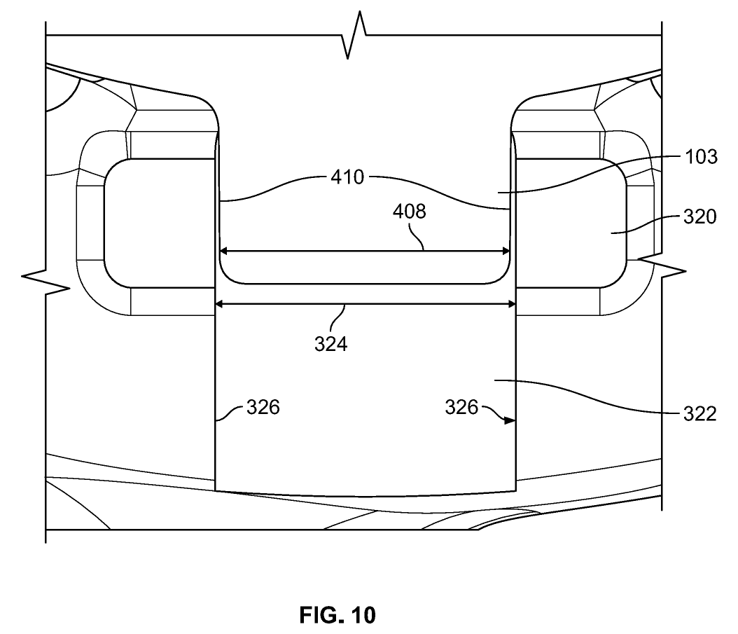

In FIGS. 8 and 13, the thrust spacer 102 includes the anti-rotation feature or tang 103 that assembles with the horizontal slot portion 320 and the vertical slot portion 322 to prevent rotation of the thrust spacer 102 in clockwise and anticlockwise directions due to rotation of the crankshaft. The thrust spacer 102 includes the front surface 404 opposite the back surface 406 and a spacer thickness T11 that spans between the front surface 404 and the back surface 406. The thrust spacer 102 is bi-directional such that the front surface 404 is the same as the back surface 406 and the thrust spacer 102 is symmetric about the centerline of the thrust spacer 102. In one embodiment, the thrust spacer 102 is a steel stamped part but in other embodiments can be made of a different material or by a different method of manufacture. The thrust spacer 102 being bi-directional minimizes assembly errors with assembly of the thrust spacer 102 with the main bearing cap 52 and the front and rear thrust bearings 110 and 111. The thrust spacer 102 having the spacer thickness T11 that is less than any of the axial thicknesses T1-T4 of the front and rear thrust bearings 110 and 111 ensures that the front and rear thrust bearings 110 and 111 receive and bear any load or force from the operation of the crankshaft. Accordingly, the thrust spacer 102 does not receive and bear any load or force from the operation of the crankshaft.

The tang 103 includes a tang width 412 that spans between the tang vertical edges 410. The tang 103 is positioned along a centerline of the thrust spacer 102. The difference in the widths 324 and 412 results in a tang clearance or gap between a tang vertical edge 410 of the tang 103 and the vertical wall 326 of the vertical slot portion 322 of the tang slot 302. The tang vertical edges 410 have a tang length that is sufficient to extend along a depth or a portion of the depth of the horizontal slot portion 320 of the tang slot 302. The central location of the tang 103 on the thrust spacer 102 prevents rotation of the thrust spacer 102 in the thrust support groove or bevel 312 during operation of the crankshaft. Therefore, the tang 103 prevents rotation of the front and rear thrust bearings 110 and 111 during operation of the crankshaft and maintains the position of the front and rear thrust bearings 110 and 111. The tang 103 is larger than the poke-yoke 135 such that the tang 103 on the thrust spacer 102 prevents rotation of the front and rear thrust bearings 110 and 111 without fear of breakage of the poke-yoke 135. As such, the poke-yoke 135 is for positional control of the front and rear thrust bearings 110 and 111 and not for prevention of rotation of the front and rear thrust bearings 110 and 111.

The thrust spacer 102 includes a thrust spacer outer edge 420 having an outer radius 408 that spans between thrust spacer ends 430a, 430b wherein the ends 430a and 430b are configured the same. The thrust spacer 102 includes a thrust spacer inner edge 426 having an inner radius 424 that spans between chamfer ends 432a, 432b. The chamfer ends 432a, 432b are positioned a distance 434a, 434b from the thrust spacer ends 430a, 430b. The thrust spacer 102 includes a width 428 that spans between the thrust spacer inner and outer edges 426 and 420. The chamfer ends 432a, 432b are tapered relative to the width 428.

As is evident from the figures and text presented above, a variety of aspects of the present disclosure are contemplated.

Various aspects of the present application are contemplated. According to one aspect, a thrust system comprising: a semi-annularly shaped half thrust bearing including a slide surface opposite a back surface, wherein the half thrust bearing has a bearing thickness that spans between the slide surface and the back surface; and a semi-annularly shaped half thrust spacer having a front surface opposite a back surface, wherein the half thrust spacer has a spacer thickness that spans between the front surface and the back surface, wherein the spacer thickness is less than the bearing thickness.

In one embodiment, wherein the thrust spacer includes a tang positioned along a centerline of the thrust spacer to resist rotation of the thrust spacer.

In one embodiment, wherein the tang includes a pair of vertical edges wherein each of the edges has a tang length that corresponds to a depth of a tang slot of a main bearing cap when the half thrust spacer is assembled with the main bearing cap.

In one embodiment, wherein the thrust spacer is symmetric about a centerline of the thrust spacer.

In one embodiment, wherein the front surface is the same as the back surface of the thrust spacer.

In one embodiment, wherein the half thrust bearing includes a poke-yoke and the tang is larger than the poke-yoke.

In one embodiment, wherein the half thrust bearing includes a front thrust bearing and a rear thrust bearing, wherein the half thrust spacer is symmetric for assembly with either of the front thrust bearing or the rear thrust bearing.

According to another aspect, a thrust system comprising: a semi-annularly shaped half thrust bearing including a poke-yoke; and a semi-annularly shaped half thrust spacer having a tang positioned along a centerline of the thrust spacer to resist rotation of the thrust spacer, wherein the tang is larger than the poke-yoke.

In one embodiment, wherein the semi-annularly shaped half thrust bearing includes a slide surface opposite a back surface, wherein the half thrust bearing has a bearing thickness that spans between the slide surface and the back surface; and wherein the semi-annularly shaped half thrust spacer has a front surface opposite a back surface, wherein the half thrust spacer has a spacer thickness that spans between the front surface and the back surface, wherein the spacer thickness is less than the bearing thickness.

In one embodiment, wherein the half thrust spacer is symmetrical such that the front surface is the same as the back surface.

In one embodiment, wherein the half thrust bearing includes a front thrust bearing and a rear thrust bearing, wherein the half thrust spacer can be assembled with either of the front thrust bearing or the rear thrust bearing.

In one embodiment, wherein the tang includes a pair of vertical edges wherein each of the edges has a tang length that corresponds to a depth of a tang slot of a main bearing cap when the half thrust spacer is assembled with the main bearing cap.

According to another aspect, a thrust system for assembly with a main bearing cap comprising: a semi-annularly shaped half thrust bearing configured for assembly with the main bearing cap; a semi-annularly shaped half thrust spacer having a thrust spacer outer edge defined by an outer radius, the thrust spacer includes a tang positioned along a centerline of the thrust spacer; and wherein the main bearing cap includes a thrust support groove having a radius that corresponds to the outer radius of the thrust spacer to retain the thrust spacer assembled with the main bearing cap, the main bearing cap having a tang slot sized to receive the tang to resist rotation of the thrust spacer relative to the main bearing cap.

In one embodiment, wherein the tang slot includes a vertical slot portion having a width that is wider than a width of the tang to form a tang clearance.

In one embodiment, wherein the tang clearance is between 0.12 and 0.37 millimeters.

In one embodiment, wherein the semi-annularly shaped half thrust bearing includes a slide surface opposite a back surface, wherein the half thrust bearing has a bearing thickness that spans between the slide surface and the back surface; and wherein the semi-annularly shaped half thrust spacer has a front surface opposite a back surface, wherein the half thrust spacer has a spacer thickness that spans between the front surface and the back surface, wherein the spacer thickness is less than the bearing thickness.

In one embodiment, wherein the half thrust bearing includes a front thrust bearing and a rear thrust bearing, wherein the half thrust spacer can be assembled with either of the front thrust bearing or the rear thrust bearing.

In one embodiment, wherein each of the front and rear thrust bearings includes a poke-yoke, and wherein the tang is larger than the poke-yoke of either the front or the rear thrust bearings.

In one embodiment, wherein the poke-yoke of the front or the rear thrust bearings is configured to prevent assembly of the front or the rear thrust bearings in a backwards orientation.

In one embodiment, wherein the slide surface includes one or more ramp profiles, and the back surface is flat.

In the above description, certain relative terms may be used such as “up,” “down,” “upper,” “lower,” “horizontal,” “vertical,” “left,” “right,” “proximal,” “distal,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In some instances, the benefit of simplicity may provide operational and economic benefits and exclusion of certain elements described herein is contemplated as within the scope of the invention herein by the inventors to achieve such benefits. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A thrust system comprising:
a semi-annularly shaped half thrust bearing including a slide surface opposite a back surface, wherein the half thrust bearing has a bearing thickness that spans between the slide surface and the back surface; and
a semi-annularly shaped half thrust spacer having a front surface opposite a back surface, wherein the half thrust spacer has a spacer thickness that spans between the front surface and the back surface, wherein the spacer thickness is less than the bearing thickness.

2. The thrust system of claim 1, wherein the thrust spacer includes a tang positioned along a centerline of the thrust spacer to resist rotation of the thrust spacer.

3. The thrust system of claim 2, wherein the tang includes a pair of vertical edges wherein each of the edges has a tang length that corresponds to a depth of a tang slot of a main bearing cap when the half thrust spacer is assembled with the main bearing cap.

4. The thrust system of claim 2, wherein the thrust spacer is symmetric about a centerline of the thrust spacer.

5. The thrust system of claim 2, wherein the front surface is the same as the back surface of the thrust spacer.

6. The thrust system of claim 2, wherein the half thrust bearing includes a poke-yoke and the tang is larger than the poke-yoke.

7. The thrust system of claim 1, wherein the half thrust bearing includes a front thrust bearing and a rear thrust bearing, wherein the half thrust spacer is symmetric for assembly with either of the front thrust bearing or the rear thrust bearing.

8. A thrust system comprising:
a semi-annularly shaped half thrust bearing including a poke-yoke; and
a semi-annularly shaped half thrust spacer having a tang positioned along a centerline of the thrust spacer to resist rotation of the thrust spacer, wherein the tang is larger than the poke-yoke.

9. The thrust system of claim 8, wherein the semi-annularly shaped half thrust bearing includes a slide surface opposite a back surface, wherein the half thrust bearing has a bearing thickness that spans between the slide surface and the back surface; and
wherein the semi-annularly shaped half thrust spacer has a front surface opposite a back surface, wherein the half thrust spacer has a spacer thickness that spans between the front surface and the back surface, wherein the spacer thickness is less than the bearing thickness.

10. The thrust system of claim 9, wherein the half thrust spacer is symmetrical such that the front surface is the same as the back surface.

11. The thrust system of claim 10, wherein the half thrust bearing includes a front thrust bearing and a rear thrust bearing, wherein the half thrust spacer can be assembled with either of the front thrust bearing or the rear thrust bearing.

12. The thrust system of claim 8, wherein the tang includes a pair of vertical edges wherein each of the edges has a tang length that corresponds to a depth of a tang slot of a main bearing cap when the half thrust spacer is assembled with the main bearing cap.

13. A thrust system for assembly with a main bearing cap comprising:
a semi-annularly shaped half thrust bearing configured for assembly with the main bearing cap;
a semi-annularly shaped half thrust spacer having a thrust spacer outer edge defined by an outer radius, the thrust spacer includes a tang positioned along a centerline of the thrust spacer; and
wherein the main bearing cap includes a thrust support groove having a radius that corresponds to the outer radius of the thrust spacer to retain the thrust spacer assembled with the main bearing cap, the main bearing cap having a tang slot sized to receive the tang to resist rotation of the thrust spacer relative to the main bearing cap.

14. The thrust system of claim 13, wherein the tang slot includes a vertical slot portion having a width that is wider than a width of the tang to form a tang clearance.

15. The thrust system of claim 14, wherein the tang clearance is between 0.12 and 0.37 millimeters.

16. The thrust system of claim 14, wherein the semi-annularly shaped half thrust bearing includes a slide surface opposite a back surface, wherein the half thrust bearing has a bearing thickness that spans between the slide surface and the back surface; and
wherein the semi-annularly shaped half thrust spacer has a front surface opposite a back surface, wherein the half thrust spacer has a spacer thickness that spans between the front surface and the back surface, wherein the spacer thickness is less than the bearing thickness.

17. The thrust system of claim 16, wherein the half thrust bearing includes a front thrust bearing and a rear thrust bearing, wherein the half thrust spacer can be assembled with either of the front thrust bearing or the rear thrust bearing.

18. The thrust system of claim 17, wherein each of the front and rear thrust bearings includes a poke-yoke, and wherein the tang is larger than the poke-yoke of either the front or the rear thrust bearings.

19. The thrust system of claim 18, wherein the poke-yoke of the front or the rear thrust bearings is configured to prevent assembly of the front or the rear thrust bearings in a backwards orientation.

20. The thrust system of claim 19, wherein the slide surface includes one or more ramp profiles, and the back surface is flat.
